(19) United States
(12) Patent Application Publication
(10) Pub. No.: US 2014/0379563 A1
(43) Pub. Date: Dec. 25, 2014

(54) APPARATUS AND METHODS FOR WEB INITIATED PHONE PAYMENTS

(71) Applicant: GAURAV BAZAZ, EDGEWATER, NJ (US)

(72) Inventor: GAURAV BAZAZ, EDGEWATER, NJ (US)

(21) Appl. No.: 14/311,349

(22) Filed: Jun. 23, 2014

Related U.S. Application Data
(60) Provisional application No. 61/838,320, filed on Jun. 23, 2013.

(51) Int. Cl. G06Q 20/30

(52) U.S. Cl. CPC G06Q 20/305
USPC 705/39

(57) ABSTRACT

A method and apparatus is disclosed for completing transactions initiated on online internet websites and completed with payments over phone. The process allows users an easy, convenient and secure method for making online payments without using credit or debit cards.

### RELATED APPLICATION

This application claims the benefit of priority to U.S. Provisional Application 61/838,320 filed 23 Jun. 2013, the entire disclosure of which is incorporated by reference.

### BACKGROUND

A very large number of transactions today happen over the internet whereby consumers make purchases on internet websites and make payments on the sites using credit or debit cards. The process involves the user entering their credit or debit card number along with various other identification details to authenticate the transaction. This is followed by the ecommerce system behind the website debiting the purchase amount from the user's account using standard processes.

### SUMMARY OF INVENTION

Most online commerce (‘ecommerce’) involves payments made using debit or credit cards. The user, upon completing a purchase, enters his debit or credit card number on the website where he is making the purchase along with identification details such as phone numbers, address, CVV codes, name on card etc. Once all the details are entered, the user submits the information on the website. The website then captures the details and sends them to a payment processor. The payment processor authenticates the details to ensure the details are correct, and then proceeds to close the transaction by transferring the invoice amount from the customer's account to the merchant's account.

This process involves various points of friction and inconvenience for the user, and also can be highly insecure. The user has to have his credit or debit card handy at the time of the transaction. The user needs to enter a lot of details on the website which can be time consuming and frustrating, especially when websites fail or show errors and user has to re-enter information. It is also insecure as the user has to reveal a lot of personal information to authenticate the transaction.

We propose a method and apparatus for making payments for online purchases that eliminates or mitigates most of these issues. The method allows for users to make payments using their phones in a simple two step process.

As described herein, when the user is making a purchase on an online website, and has completed the process except for payment, the user will be presented with the option to pay by phone. The phone payment option will be handled by the merchant itself or by a third party.

If the user chooses to pay by phone, the user will be presented with a web form textbox where the user can enter his phone number. Once the user has entered and submitted his phone number, a call will be initiated from the merchant to the user. When the user picks up the call, the user may be presented with some details about the transaction such as the merchant name, product purchased, invoice amount etc. The customer will be asked to enter a secret code to complete the transaction. The code could be a simple series of digits the customer can enter over the keypad of the phone. Once the user has entered the code, it will be transmitted to the calling system. This system then authenticates the code against previously stored secret code for the customer. If the correct code is provided, the transaction is completed, and a message may be relayed to customer over the phone, by voice or text indicating the successful completion of the transaction. The merchant website will also at this point update to reflect that the transaction has completed. The completion of the transaction, upon entry of correct code, involves debiting of the required amount from the payer's account and transferring to the seller's account. In another embodiment, instead of a series of digits being entered on the phone keypad, the system may use a voice-key which the user will speak into the phone, and the voice will be analyzed by the transaction processor's computers to authenticate the user. Also, if the code entered is incorrect, the customer may be given another opportunity to enter the code. A fixed number of opportunities may be given to the customer to enter the correct code, after which the transaction will be cancelled if the correct code is not provided.

In the backend, when the user selects the choice of paying by phone, the phone payment system receives the phone number of the customer. It checks if this phone number is already part of a registered account. If it is, it initiates a call to the customer. When the customer accepts the call, the system may play some static or dynamic messages to inform the customer of the nature of the call. It will then request the user to enter the secret passcode or an equivalent secret key associated with that customer's account within the system. When the customer enters the code or secret key, the system checks if the code matches the code associated with the phone number in the system. If it doesn't match, it requests the code again. If it does match, it finds the credit card, or debit card or bank details associated with the customer within the system and initiates a transaction with the internal or external payment processor to transfer payment amount from the user to the merchant. Once the transaction completes with the payment processor, it may return a completion message to the customer over the phone and/or on the website or by other channels such as email.

In case the customer does not already have an account with the phone payment system, which includes the customer's phone number, secret key and payment details such as credit or debit card or bank details, then the phone payment system may yet carry out the transaction on a provisional basis. Here, the system will auto-create a new account with the given phone number in the system and ask the user to confirm the transaction. Once confirmed, it will request the user to complete the setup of his account over an online system or by mail or by phone or some other channel. Once the customer completes the account setup, by adding a passcode and relevant payment details such as credit card number or bank account details to his account, possibly within a certain time limit, the transaction will be re-processed, with the actual payment details sent to the payment processor and invoice amount being transferred from user account to the merchant.

The model therefore requires 4 entities:
a. A user account in a central database which stores the user's phone number, secret key and payment details and possibly other relevant information. The payment details may be credit card numbers, debit card numbers, back account information or other such information that allows a conventional payment processor to debit money from the user's account and post it to another entity's account. The details may be stored in a single database or spread across different databases.
b. A website system that allows the user to initiate the payment transaction by entering a phone number and requesting a call.
c. An authentication system whereby the user, on receiving the payment call, can authorize the transaction securely by entering the secret key.
d. A payment manager system that receives the request to initiate the pay-by-phone process from the merchant website, makes the call to the customer, authenticates the customer's secret key against information in the central database, and initiates the process to make the actual payment transfer from customer to merchant, after which it issues a confirmation of completion of transaction, or message of failure, if it fails.

The user may also have multiple payment options associated with his account, such as credit card, debit card and bank account. In this case, the user may choose one default method which would be used to process the transaction unless it fails. We can also have an algorithm that might automatically select the account to debit the transaction amount from, based on some criteria, in order to minimize user costs or maximize benefits such as rebate points from credit cards.

In another embodiment, instead of the pay-by-phone system calling the user, the website will display a phone number to the user to call, possibly with a transaction code. The user will dial the given number, and enter the transaction code. After this, the system will request the user to enter the secret key to authenticate. If the secret key is correct, the transaction will be completed. The transaction code here helps the system identify which transaction the user is trying to make a payment for, since the system may have many users, possibly simultaneously using it and all calling the same phone number, the system needs to connect the user's call to a particular transaction. In another model, the phone number displayed on the website to the user, will be a ‘concurrently unique’ phone number, and there will be no transaction code required. The user will simply call the given number, and enter the secret key to complete the transaction. ‘Concurrently unique’ here implies, that the given phone number is used only for the one given user's transaction, and no other user on the system, at the same time, or for a period of time before or after the user requests the payment-by-phone process, is given the same number to call. So the phone number is unique to the given transaction and therefore automatically identifies the transaction. Once the transaction is completed, the phone number may be re-used for another transaction by another user. However, the phone number will not be provided to another user to authenticate her transaction, at least until the current user has authenticated his transaction, up to a certain time limit, at which point the current user's transaction will be cancelled and the phone number released for re-use by another user. Naturally, this system requires lot of phone numbers to be available to the system at any given time to support all concurrent users.

### DESCRIPTION OF DRAWINGS

FIG. 1 shows the process flow of the current innovation. The process starts at 001 with the customer making an online purchase at 002. Once the purchase is made on the website by the user, she proceeds to the payment section on the website. At the payment section the user gets the option to pay by phone or other methods, as shown in 004. If the user chooses to pay by other methods, she proceeds to pay by those conventional methods as shown in 017. If she chooses to pay by phone, she enters the phone number on the screen, as shown at 006. Once the user enters the phone number, a call is initiated to the customer as shown at 008. Some background information about the transaction may be provided to the user to provide context. At the end the customer is asked to enter her secret code to authorize the transaction at 010. Once the user enters the code at 012, the system checks if the code is correct at 014. If the code is correct, the purchase is authorized and the required funds debited from the user's account and transferred to the merchant's account at 016, though this may not happen immediately and some further processing may occur before it's completed. If the secret code is incorrect at 014, the user will be given the chance to enter the code again at 010, for a fixed number of tries.

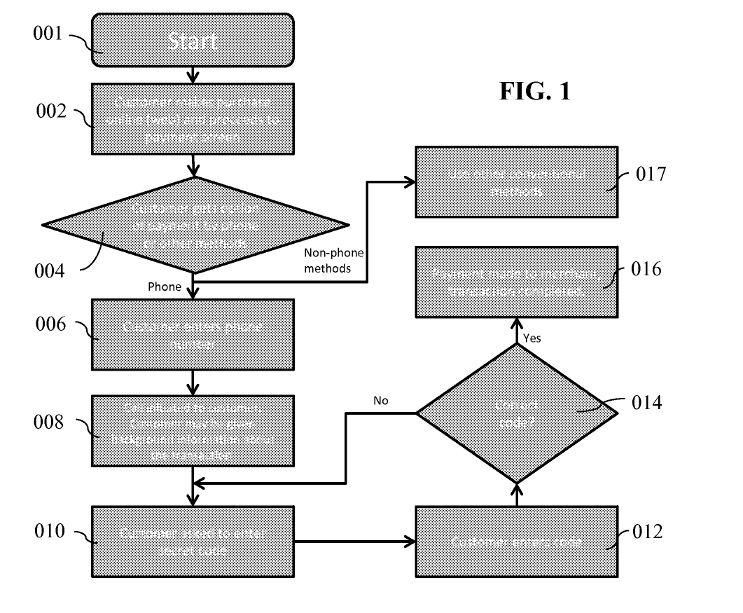

FIG. 2 shows one model for executing the above process. Here the merchant acts as the primary intermediary for executing the transaction and the pay-by-phone processing module is owned by the merchant. In another model, shown in FIG. 3, the pay-by-phone processing module is owned by a third party and the third party acts as the primary intermediary. In the first model of FIG. 2, the merchant 018 starts by requesting the secret code at 023 from the customer 022 to authorize the transaction over the phone, after the user has selected pay-by-phone as his payment option. The customer returns the secret code to the merchant at 024 by entering it on the phone. The merchant 018 sends the code to the pay-by-phone processing module 028 at 025. The pay-by-phone processing module 028 authenticates the transaction and completes the transaction by debiting the amount from the customer's account into the merchant's account. The pay-by-phone processing module 028 maybe part of the merchant 018 or a separate entity entirely. The processing module 028 then returns the transaction confirmation to the merchant at 026. The merchant then closes the transaction by confirming the completion of the purchase to the customer at 027. In order to make this model work a contractual relationship needs to exist between the Merchant and pay-by-processing module as shown in 028. Similarly, a contractual relationship between the customer and pay-by-phone processing module is required as shown in 030.

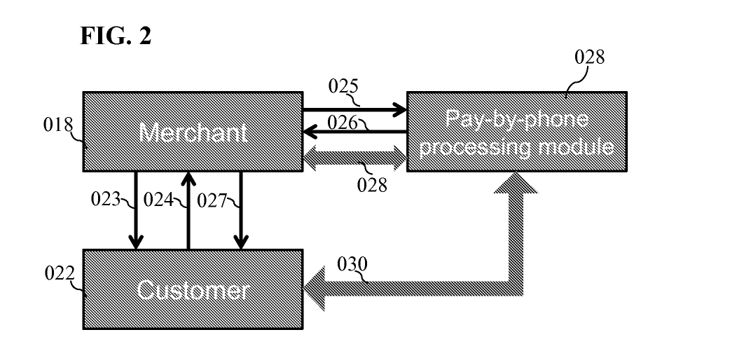

FIG. 3 shows another model for executing the process described in the current invention. Here the pay-by-phone processing module 028 is owned by a third party which acts as the main intermediary managing the transaction. When a purchase is made and phone payment requested by the user, the merchant 018 sends a request 032 to the pay-by-phone processing module 028 to collect payment for the transaction. The request may contain relevant information to allow the pay-by-phone processing module 028 to execute the request, such as transaction items, transaction amount, customer name etc. The processing module 028 then initiates a call to the customer and requests the secret code at 033. The customer 022 responds with the secret code at 034. The processing module 028 then authenticates this code. If correct, the transaction is completed and required amount debited from client account into the merchant account. The processing module 028 then sends a transaction completion confirmation to the merchant 018 at 035. Once the merchant 018 receives the confirmation it can send a confirmation of completion of purchase to the customer 022 at 036. For this model to be implemented a contractual relationship 038 is required between the merchant and the pay-by-phone processing module owning third party. Also a contractual relationship 040 is required between the customer and the pay-by-phone processing module owning third party.

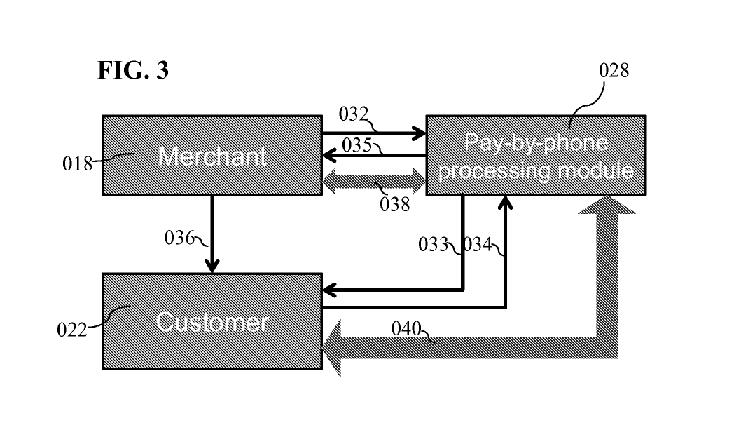

FIG. 4 shows a simplified view of a possible embodiment of an interface offering the user the opportunity to pay by phone instead of conventional methods such as credit cards. The screen 044 has the name of the merchant 042 at the top. The screen describes the current purchase 046 of the user at the top. It then presents the user with two options for making the payment. A credit card option 048 and a phone option 050. If the user chooses the pay-by-phone option, she will enter her phone number in the textbox 051, in the pay-by-phone section 050. She will then click the submit button 052. At this point, the pay-by-phone system will be activated and it will initiate a call to the user.

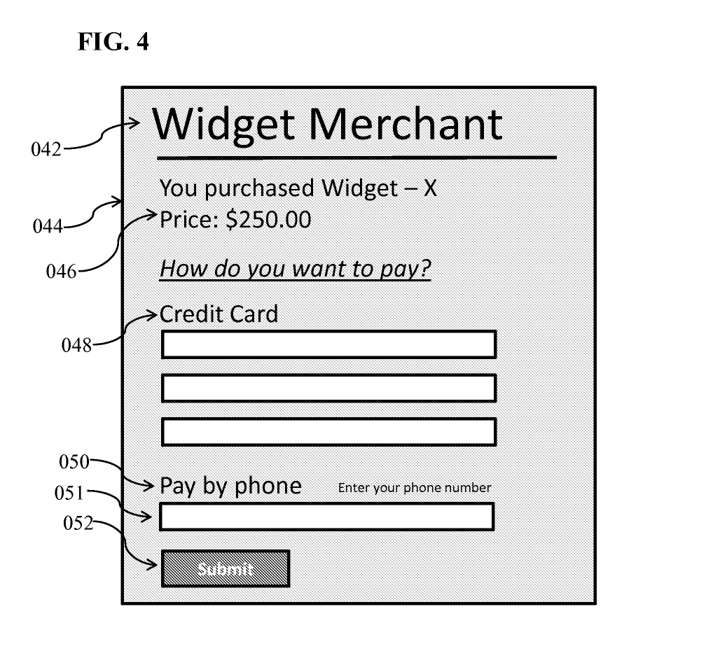

FIG. 5 shows another model for the process flow of the current invention. This figure describes the model where the user is displayed the phone number to call along with a transaction code on the website. The process starts at 054 and the user makes the purchase at 056. At 058 the user is given the option to pay by phone or use another payment method. If the user chooses another method, he proceeds to 072 to make payment using the alternative method. If the user chooses at 058 to pay by phone, the user proceeds to 060 where the website displays a phone number the user can call to make the call and also a transaction code. The phone number and transaction code may also be visible on the website before the user chooses the pay-by-phone option. Next, the user calls the provided number and when prompted enters the transaction code at 062. This helps the pay-by-phone system, which received the call, to identify the transaction for which the user is calling. Next the system prompts the user to enter the secret key to authenticate the transaction at 064. The user enters the secret key at 066 and if the key matches the secret key on record in the pay-by-phone system at 068, the transaction is completed at 070. If there is no match, the user is returned to 064 to try again.

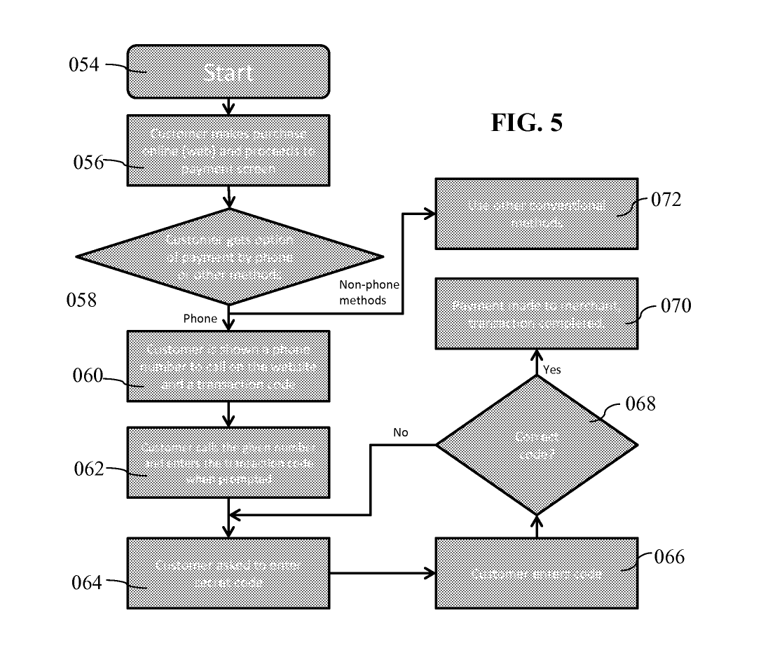

FIG. 6 shows another model for the process flow of the current invention. This figure describes the model where the user is shown the phone number to call on the website and no transaction code is required. The process starts at 074 and the user makes the purchase at 076. At 078 the user is given the option to pay by phone or use another payment method. If the user chooses another method, he proceeds to 092 to make payment using the alternative method. If the user chooses at 078 to pay-by-phone, the user proceeds to 080 where the website displays a phone number the user can call to make the call and pay for the purchase. The phone number may also be visible on the website before the user chooses the pay-by-phone option. Next, the user calls the provided number at 082. The unique number called by the user automatically identifies the transaction to the pay-by-phone system which received the call. Next the system prompts the user to enter the secret key to authenticate the transaction at 084. The user enters the secret key at 086 and if the key matches the secret key on record in the pay-by-phone system at 088, the transaction is completed at 090. If there is no match, the user is returned to 084 to try again.

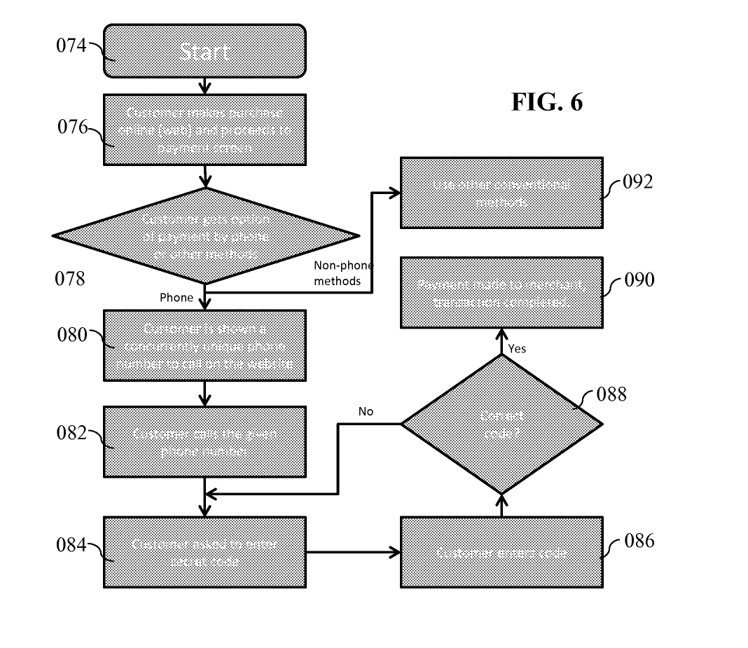

FIG. 7 shows a simplified view of a possible embodiment of an interface offering the user the opportunity to pay by phone instead of conventional methods such as credit cards, wherein the user calls the pay-by-phone system. The screen 096 has the name of the merchant 094 at the top. The screen describes the current purchase 098 of the user at the top. It then presents the user with two options for making the payment. A credit card option 100 and a phone option 102. If the user chooses the pay-by-phone option, she will dial the phone number in the box 104, in the pay-by-phone section 102. She will then enter the secret key and complete the transaction.

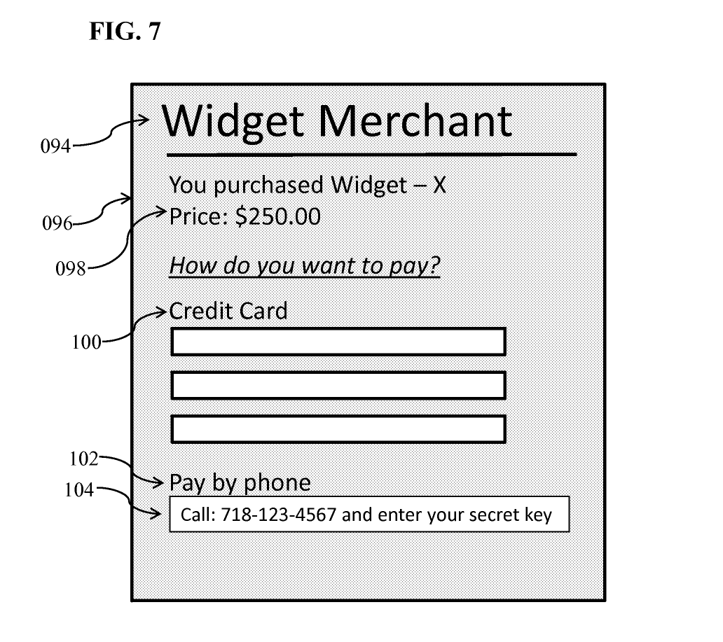

1. A computer program product comprising a computer-readable medium having computer-executable instructions stored thereon, the computer-executable instructions comprising a pay-by-phone system for performing a method comprising:
a. collecting from a user who is a buyer his or her phone number from an internet connected website, when the user is engaged in a transaction to purchase an item from a merchant;
b. transmitting said submitted phone number to an internal or third party pay-by-phone processing module upon said user submitting said phone number on said website;
c. checking if said phone number is associated with an existing customer account in a database operatively connected to said pay-by-phone processing module, and if it is, initiating a call to said user's said phone number;
d. requesting said user to enter a secret code through said user's phone instrument upon said user replying to said call from said pay-by-phone processing module;
e. verifying said secret code against previously provided secret code stored in a database operatively connected to said pay-by-phone processing module and associated with said user's phone number in said user's account in said pay-by-phone processing module upon said user submitting said secret code;
f. processing a transaction by having the invoice amount of said transaction debited from said user's account using a payment source previously provided by said user to said pay-by-phone processing module, and having said invoice amount credited to said merchant upon correct verification of said secret code; and
g. providing a confirmation message to said user and to said merchant upon completion of said transaction,
whereby said buyer is able to pay said merchant for said purchase initiated on said website by submitting said phone number.

2. A computer program product comprising a computer-readable medium having computer-executable instructions stored thereon, the computer-executable instructions comprising a pay-by-phone system for performing a method comprising:
a. providing to a user who is a buyer purchasing an item from a merchant, a phone number to call and a transaction code associated with said purchase transaction, from an internet connected website;
b. receiving a call into a pay-by-phone processing module from said user at said phone number upon said user calling said phone number and requesting said transaction code from said user to identify said transaction;
c. verifying said transaction code in said pay-by-phone processing module to identify said transaction and verifying if said phone number from which call has been made by said user is associated with an existing customer in said pay-by-phone processing module, and upon verification requesting said user to provide a secret code through said user's phone;
d. verifying said secret code against a previously provided code stored in a database operatively connected to said pay-by-phone processing module and associated with said user's phone number in said user's account in said pay-by-phone processing module;
e. upon verification of said secret code, processing a transaction by having the invoice amount of said purchase debited from said user's account using a payment source previously provided by said user to said pay-by-phone processing module, and having said invoice amount credited to said merchant; and
f. upon completion of said transaction, providing a confirmation message to said user and to said merchant,
whereby said user is able to pay said merchant for said purchase transaction initiated on said website by dialing said phone number and providing said transaction code.

3. A computer program product comprising a computer-readable medium having computer-executable instructions stored thereon, the computer-executable instructions comprising a pay-by-phone system for performing a method comprising:
a. providing to a user who is a buyer of an item from a merchant, a concurrently unique phone number to call, from an internet connected website;
b. upon said user calling said phone number, a pay-by-phone processing module receives said call and requests a secret code from said user to verify said transaction;
c. upon said user submitting said secret code, said pay-by-phone processing module verifying said code against previously provided code stored in a database operatively connected to said pay-by-phone processing module and associated with said user's phone number in said user's account in said pay-by-phone processing module;
d. upon correct verification of said secret code, processing a transaction by having the invoice amount of said purchase transaction debited from said user's account using a payment source previously provided by said user to said pay-by-phone processing module, and having said invoice amount credited to said merchant; and
e. upon completion of said transaction, providing a confirmation message to said user and to said merchant,
whereby said user is able to pay said merchant for said purchase transaction initiated over said website by dialing said phone number.
